(19) United States
(12) Patent Application Publication
(10) Pub. No.: US 2007/0201701 A1
(43) Pub. Date: Aug. 30, 2007

(54) Prepaid access control method

(75) Inventor: Andre Kudelski, Lutry (CH)

Correspondence Address: HARNESS, DICKEY & PIERCE, P.L.C., P.O. BOX 8910, RESTON, VA, 20195, US

(73) Assignee: NagraCard S.A.

(21) Appl. No.: 11/702,579

(22) Filed: Feb. 6, 2007

(30) Foreign Application Priority Data
Feb. 10, 2006 (EP) EP 06101564.0

(51) Int. Cl. H04L 9/00

(52) U.S. Cl. 380/277

(57) ABSTRACT

The present invention aims at minimising the impact of an attack on the reloading of the credit into a security module connected to a Pay-TV decoder. The solution to this problem resides in a prepaid access control method to television products broadcasted in a data stream to a Pay-TV decoder linked to a security module having a credit, this method comprising the following steps: receiving of a security message (ECM) comprising a temporary key (CW) allowing the decryption of at least a part of the data stream, verifying access to said data on the basis of the rights contained in the security module, if the verification is positive, verifying of a counter a temporary keys sent to the decoder and determining if a limit has been reached, transmitting the temporary key if the limit is not reached and updating the temporary key counter.

### INTRODUCTION

The present invention relates to the Pay-TV domain, in particular the protection of conditional access data.

### STATE OF THE ART

In order to access products or conditional access services, the user disposes of a receiver/decoder that receives the stream in an encrypted form and of a security module responsible for access control operations.

Therefore, in the data stream, the security messages are also transmitted that contain the keys allowing the decryption of the encrypted stream. These messages are themselves encrypted by a key of which only the security module disposes, the latter receiving the messages and verifying the rights of the user before returning the temporary key (Control Word) authorising the decoder to decrypt the data.

In the document WO03085959, the access to services or products is carried out by the management of a credit in the security module. Each television product corresponds to a price, either for the entirety of the product or corresponding to a time unit. The credit is decreased as the processing of the data stream proceeds, namely the processing of a security message (ECM) and the returning of the current key to the decoder.

As long as the credit is positive, the security module accepts the processing of the security message and returns the corresponding key to the decoder. Once the credit has run out, the security module refuses to return the key of the security message and the decryption of the stream is thus interrupted.

Therefore, if a third party is successful in breaking the method for reloading the credit, this third party will also have unlimited access to all the products even though the security of the security messages is not compromised.

### BRIEF DESCRIPTION OF THE INVENTION

There remains thus an unsolved problem, namely to minimise the impact of an attack on the reloading of credit in a security module attached to a Pay-TV decoder.

The solution to this problem is found in a prepaid access control method to television products broadcasted in a data stream to a Pay-TV decoder linked to a security module having a credit, this method comprising the following steps:
receiving of a security message (ECM) comprising a temporary key (CW) allowing the decryption of at least a part of the data stream,
verifying access to said data on the basis of the rights contained in the security module,
if the verification is positive, verifying of a counter a temporary keys sent to the decoder and determining if a limit has been reached,
   transmitting the temporary key if the limit is not reached and updating the temporary key counter

According to the invention, the verification process of the rights of the user is carried out in three steps. Firstly, the rights are verified, for example by the existence of a credit in the security module. This credit can be managed in two ways, either by the purchase of a television product and the storage of a corresponding right in the security module, or by the purchase according to time (or to a security message number). In the first embodiment, a right message (EMM) is processed by the security module and the purchase of a product has the effect of decreasing the credit of a predefined amount and storing a right in the security module. All the security messages (ECM) will be authorised as they contain as a condition the presence of this right. On reception of said message, the security module verifies that the right is present and does not carry out any action on the credit. In the second embodiment, it is directly the security message that causes the decrease of the credit to an amount that is predefined and can, for example, be contained in the security message itself. It should be noted that in this second alternative, it is not necessary for each message to cause the debit of the credit, a debit can activate a period of a few minutes during which all other messages will be decrypted and returned to the decoder.

After this first verification, a second verification is carried out that consists in verifying the state of a temporary key counter, counting the temporary keys (or control-words) returned to the decoder. With each key returned, the counter is updated and this counter is compared to a pre-programmed limit value.

If the value of the counter has reached or exceed this limit, the security module blocks the returning of the temporary keys and access to the encrypted data stream is thus no longer possible.

### BRIEF DESCRIPTION OF THE DRAWINGS

The invention will be better understood thanks to the detailed description which makes reference to the only FIGURE that shows a Pay-TV decoder with security module.

### DETAILED DESCRIPTION

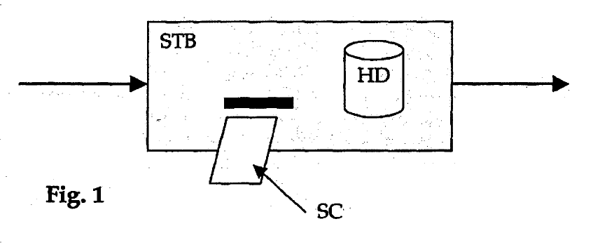

According to the example disclosed in FIG. 1, the STB decoder contains a storage media HD and is locally connected to a security module SC that is in the form of a smart card.

The security operations are generally carried out in a security module SC associated to the digital video receiver STB. This type of security module can be produced in particular according to four different forms. One of these consists in a microprocessor card, a smart card, or more generally an electronic module (taking the form of a key, of a badge, . . . ). This type of module is generally removable and connectable to the digital video recorder. The most used form is the one with electric contacts, but does not exclude a connection without contact, for example of the ISO 14443 type.

A second known form consists in an integrated circuit chip, generally placed in the digital video receiver printed circuit board in a definitive and irremovable way. An alternative is made up of a circuit wired on a base or connected such as a SIM module connector.

In a third form, the security module is integrated into an integrated circuit chip that also has another function, for example in a descrambling module of the decoder or the microprocessor of the receiver. The security module is therefore a portion of a larger Silicon circuit.

In a fourth embodiment, the security module is not realized in hardware, but rather its function is implemented only by software. Known techniques can be used to hide this software by obfuscation for example.

Given that in the four cases the function is identical although the security level differs, it will be talked of security module regardless of the way in which its function is realized or the form that can be taken by this module.

The security message ECM and right message EMM are processed by the security module SC and thus extracted from the incoming stream in order to be forwarded to the security module by the STB decoder. The rights, credits and counters are stored in the security module SC in order to maintain protection. The right verification mechanism also includes a new function that counts all the temporary keys CW returned by the security module SC.

This counter thus plays the role of a supervisor.

According to a first alternative, this counter cannot be reinitialised and thus the lifetime of the security module is predetermined in advance. Due to the fact that this counter is only initialised during manufacturing, it plays the role of a fuse according to usage criteria.

According to a second alternative, the counter can be reinitialised according to a particular security operation. A right message (EMM) can comprise a command to reinitialise the counter or to reload it to a predefined value. Alternatively, it is possible to use a particular type of message, different from the right message and thus encrypted by a different key. Therefore, the reinitialisation of such a temporary key counter will respond to high security criteria that are very rarely used.

According to one particular embodiment, reinitialisation is carried out on request of the user. When the counter reaches a value close to the maximum, a message is displayed on the display unit of the decoder to make it request a re-initialisation. With this message, the security module has previously generated a check number that must also be transmitted to the management centre. This check number can be a random number or a number representing a signature on its internal data.

The user calls the management centre to communicate his security module identification number and the check number generated by the security module. This number can comprise a random part and a part representing a signature of the security module number.

The management centre will verify the data received, namely if the security module number corresponds correctly to that transmitted with the check number and in the affirmative, transmits a reinitialisation message to the decoder connected to said security module.

In order to strengthen the security, the check number can be included in the reinitialisation message and can thus be verified in the security module. The data in the reinitialisation message can be a signature of the check number (Hash) in lieu of the check number itself. The check number contained in the message will encompass the two definitions described above.

The reinitialisation of the counter is only effective if the check number is the same as that initially transmitted to the decoder. Reinitialisation is understood to mean the resetting to zero of said counter or the loading to a preset value. This preset value can also be transmitted in the reinitialisation message. If the above example has been described by counting towards a maximum, the process can be inverted in order to decrease towards a minimum that can be zero.

The encryption of this reinitialisation message can be carried out with a key common to the right messages (EMM) or particular and unique to this type of operation.

The invention is also applied to a partial counter of the temporary keys, namely the counting of a key on two for example (even key or odd key).

1. Prepaid access control method to television products broadcasted in a data stream to a Pay-TV decoder linked to a security module having a credit, this method comprising the following steps:
receiving of a security message comprising a temporary key allowing the decryption of at least a part of the data stream,
verifying access to said data on the basis of the rights contained in the security module,
if the verification is positive, verifying of a counter a temporary keys sent to the decoder and determining if a limit has been reached,
transmitting the temporary key if the limit is not reached and updating the temporary key counter.

2. Prepaid access control method according to claim 1, wherein the access verification to said data is based on the verification of the current credit.

3. Prepaid access control method according to claim 1, wherein the access verification to said data is based on the verification of a right stored in the security module.

4. Prepaid access control method according to claim 1, wherein the temporary key counter is reinitialised by means of the reception of a right message encrypted by a personal key to said security module.

5. Prepaid access control method according to claim 1, wherein the temporary key counter is reinitialised according to the following steps:
generating by the security module of a check number pertaining to said security module,
displaying this number on a visualisation device of the decoder,
transmitting to a management centre by the user of an identifier of the security module and of the check number,
preparing by the management centre of a reinitialisation message intended for said security module comprising an identifier of the check number,
verifying by the security module of the matching between the check number generated and the identifier of the check number received,
reinitialising the temporary key counter if the verification is positive.

6. Prepaid access control method according to claim 5, wherein reinitialisation is carried out by the loading of a value contained in the re-initialisation message into the temporary key counter.
